(19) United States
(12) Patent Application Publication
(10) Pub. No.: US 2015/0292498 A1
(43) Pub. Date: Oct. 15, 2015

(54) OIL PUMPING APPARATUS INCLUDING A CYCLOIDAL SPEED-REDUCTION MECHANISM

(71) Applicant: Rotec Engineering, Brownwood, TX (US)

(72) Inventor: Robert W. Williams, Brownwood, TX (US)

(73) Assignee: Rotec Engineering, Brownwood, TX (US)

(21) Appl. No.: 14/249,310

(22) Filed: Apr. 9, 2014

(51) Int. Cl. F04B 47/02; F16H 1/32

(52) U.S. Cl. CPC F04B 47/022; F16H 1/32; F16H 2001/325

(57) ABSTRACT

A compact dual-output speed-reduction mechanism for oil well pumps includes a housing containing a chamber; a high-speed tubular input shaft having a first end portion journalled in a first housing opening, and an eccentric portion arranged in the housing chamber; a low-speed output shaft journalled within the input shaft, the output shaft having a first end portion extending outwardly of the housing beyond the input shaft first end portion, and a second end portion that extends beyond the input shaft second end portion and outwardly of the housing via a second housing opening opposite the first housing opening. A cycloidal speed-reduction mechanism arranged in the housing chamber is connected between the input shaft eccentric portion and the housing, and between the input shaft eccentric portion and a power transfer disk connected with the output shaft. At least one rotatably-driven device is connected with the two output shaft end portions.

### BACKGROUND OF THE INVENTION

1. Field of the Invention

A compact dual-output speed-reduction mechanism for oil well pumps and the like includes a housing containing a chamber; a high-speed tubular eccentric input shaft having a first end portion journalled in a first housing opening, and an eccentric portion arranged in the housing chamber; a low-speed output shaft journalled within the input shaft, the output shaft having a first end portion extending outwardly beyond the input shaft first end portion, and a second end portion that extends beyond the input shaft second end portion and outwardly of the housing via a second housing opening opposite the first housing opening. A speed-reducing cycloidal speed-reduction arrangement contained in the housing chamber is connected between the input shaft eccentric portion and the housing, and between the input shaft eccentric portion and a power transfer disk splined on with the output shaft. At least one rotatably-driven device is connected with the two output shaft end portions.

2. Description of Related Art

Many types of drive arrangements have been proposed for operating the walking beams of oil well pumps and the like. In the common Lufkin pumps produced by Lufkin Industries, Inc., double helical herringbone gears have proven to be the standard of excellence for pumping unit gear reducers. As evidenced by the U.S. Pat. Nos. to Moss No. 4,353,445 (which uses a toothed belt drive transmission), and Eric No. 4,715,240 (which uses an elliptical pinion arrangement), other speed-reduction proposals have been presented for driving oil well pumps. The Arndt patent No. 4,574,659 relates to a two-stage precision drive arrangement for positioning solar energy apparatus that includes a cycloidal gearing stage. In the Chinese patents Nos. CN 2926493, CN 201041217 and CN 201202443, it has been proposed to use cycloidal gearing speed-reducing arrangements in the drive mechanisms for oil well pumps.

In traditional involute gearing arrangements, when “in mesh”, only a few teeth of one gear are engaged with those of another gear. Because of this, even momentary overloads or “shock” loads cause the engaged teeth to weaken or break. Additionally, when higher reduction ratios are needed, multiple gears are required, thereby making the gear box much larger in comparison to the amount of torque delivered.

Cycloidal speed reducers are an alternate to conventional gearing, and do alleviate the problems discussed above. Cycloidal reduction allows the entire load to be carried by the entire cycloid disk and pins, as distinguished from traditional gearing in which the load is carried only by a few teeth. Cycloidal reducers thereby alleviate breakage when overloads or unbalanced loading occur. However, currently in cycloidal applications requiring dual output shafts, two prime movers and or multiple speed reducers are needed, thereby increasing both initial investment and maintenance.

The present invention was developed to provide a compact, durable dual-output cycloidal speed reducer mechanism which provides the benefits of cycloidal gearing to devices or mechanical systems requiring dual output shafts for either load balancing or multiple driven units from one power source. The dual-output cycloidal speed reducer provides two shaft ends with equal power and speed with only one prime mover in a small package, thereby making the initial investment less costly and requiring less maintenance.

### SUMMARY OF THE INVENTION

A compact, durable dual-output speed-reducing gearing unit for oil well pumps is provided, including a housing containing a chamber; a high-speed tubular eccentric input shaft having a first end portion journalled in a first housing opening, and an eccentric portion arranged in the housing chamber; a low-speed output shaft journalled within the input shaft, the output shaft having a first end portion extending outwardly beyond the input shaft first end portion, and a second end portion that extends beyond the input shaft second end portion and outwardly of the housing via a second housing opening opposite the first housing opening; and a cycloidal speed-reducing arrangement arranged in the housing chamber and connected between the input shaft eccentric portion and the housing, and between the input shaft eccentric portion and a power transfer disk connected with the output shaft. At least one rotatably-driven device is connected with the output shaft end portions.

According to a more specific object of the invention, the cycloidal disk is connected with the housing at its outer periphery by a concentrically arranged pin ring that comprises a section of the stationary housing, and by a plurality of pin ring rollers carried by the pin ring that cooperate with corresponding cam grooves contained in the outer circumferential surface of the cycloidal disk. The cycloidal disk is connected with the power transfer disk by a plurality of power transfer rollers carried by the power transfer disk that cooperate with corresponding cam openings contained in the cycloidal disk.

According to a further object, an input shaft bearing supports the input shaft for rotation in the first housing opening, and a cycloid disk bearing supports the cycloid disk for rotation about the eccentric portion of the input shaft within the housing chamber. Two output shaft bearings support the output shaft for rotation within the input shaft, and a third output shaft bearing supports the output shaft for rotation within a second housing opening opposite the first housing opening.

According to another object of the invention, the two output shaft end portions are connected with and respectively drive the rotatable crank arms of a walking beam crank-balanced pumping unit for oil wells and the like.

According to a more specific object, a prime mover (i.e. an electric motor), positioned parallel to the speed reducer, is coupled to the eccentric high-speed input shaft. The turning motion of this eccentric input shaft creates an eccentric up and down rotating movement of the cycloidal disk inside the pin ring housing. The cycloidal disk is held in place by the pin ring rollers and pins which are all in constant contact with the cycloidal disk. This movement is then transferred to the power transfer disk via the power transfer pins and rollers. The power transfer disk is coupled to the dual-output low-speed output shaft, creating concentric motion, and power and speed reduction to the low-speed output shaft.

### BRIEF DESCRIPTION OF THE DRAWINGS

Other objects and advantages of the invention will become apparent from a study of the following specification, when viewed in the light of the accompanying drawing, in which:

FIG. 1 is perspective view of a conventional crank-balanced beam type oil well pumping unit;

FIG. 2 is a front elevation view of a conventional cycloidal speed-reduction arrangement;

FIG. 3 is a longitudinal sectional view of the cycloidal speed-reduction arrangement of the present invention, and FIG. 4 is a right-end exploded view of the cycloidal reduction arrangement of FIG. 3;

FIG. 5 is a schematic top view of the cycloidal reduction apparatus of FIG. 3 connected with a balanced crank arm beam type oil well pump;

FIGS. 6 and 7 are side and end views of the housing of FIG. 3, respectively;

FIG. 8 is a longitudinal sectional view of the high-speed eccentric input shaft of the apparatus of FIG. 3; and

FIG. 9 is a longitudinal side view of the low-speed output shaft of the apparatus of FIG. 3 with the associated bearing support means.

### DETAILED DESCRIPTION OF THE INVENTION

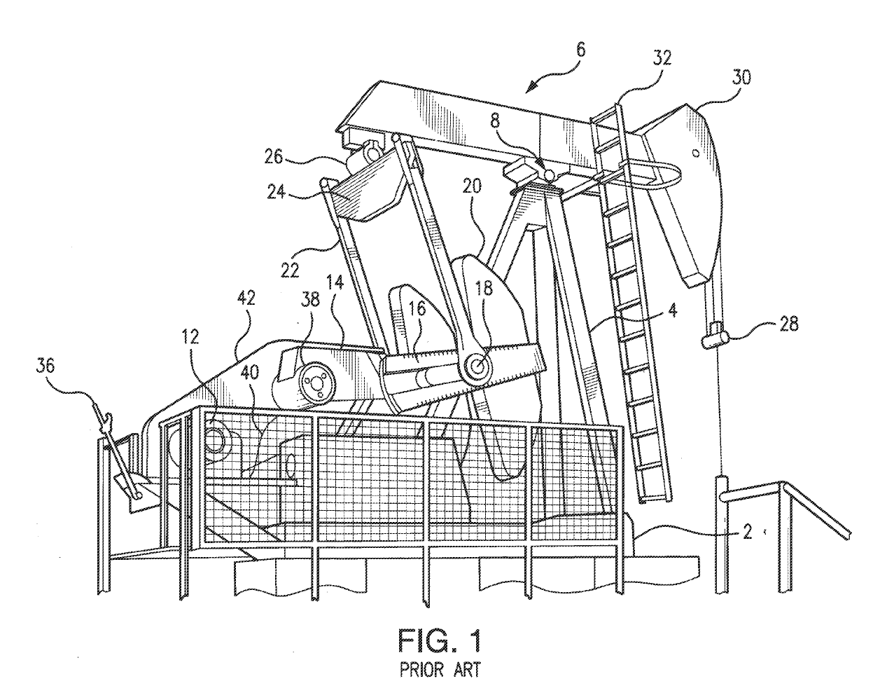

Referring first more particularly to FIG. 1, a conventional balanced crank arm walking-beam-type oil well pump, such as that produced by Lufkin Industries, Inc. of Lufkin Texas, includes a fixed base 2 which supports a Samson post 4 that carries a walking beam that pivots about a center bearing 8. The walking beam is driven at one end by a prime mover 10, such as a high speed electric motor 12, via a pinion-gear type gear reducer unit 14, a pair of crank arms 16 that pivot about crank pin bearings 18, and that are provided with counterweights 20, a pair of pitman arms 22, an equalizer 24 and an equalizer bearing 26. The other end of the walking beam is connected with an oil well sucker rod 28 via a horsehead 30, and a wireline 32. Brake lever 36 operates a braking device 38 via brake cable 40, and cover 42 covers the driving belt that connects the prime mover with the gear reducer.

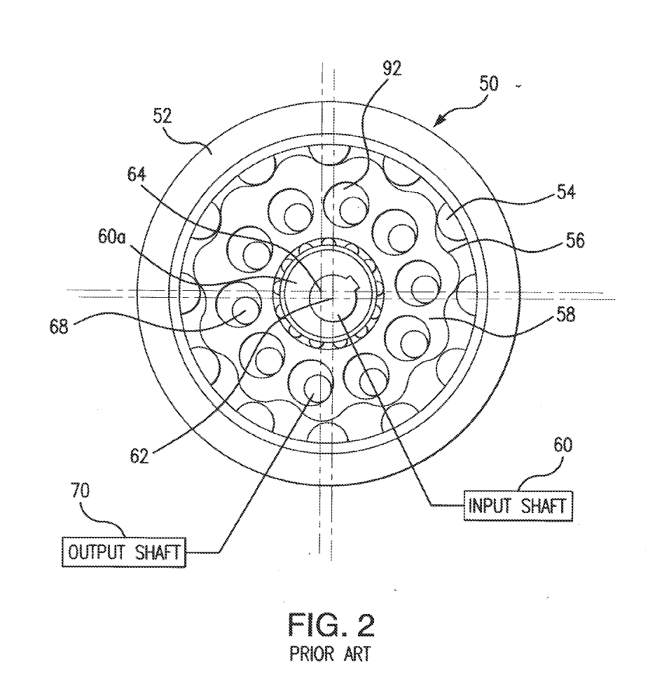

Referring now to FIG. 2, it is also known in the art to provide a cycloidal gear arrangement 50 including a stationary annular pin ring 52 that supports a plurality of circularly-arranged pin ring rollers 54 that extend into corresponding cam grooves 56 contained in the outer peripheral surface of a cycloidal disk 58. This cycloidal disk is rotatably supported on the eccentric portion 60a of a high-speed eccentric input shaft 60 having a uniform cylindrical portion that rotates about the longitudinal axis 62 of the ring gear 52. Thus, the longitudinal axis 64 of the eccentric portion 60a of the input shaft is laterally offset from the longitudinal axis 62 of the uniform cylindrical portion of the input shaft. A plurality of circularly-arranged output shaft rollers 68 carried by the low-speed output shaft 70 engage corresponding cam openings 72 contained in the cycloidal disk 58. The cycloidal reduction arrangement causes the high-input speed of the input shaft 60 to be reduced to a low-output speed for the output shaft 70.

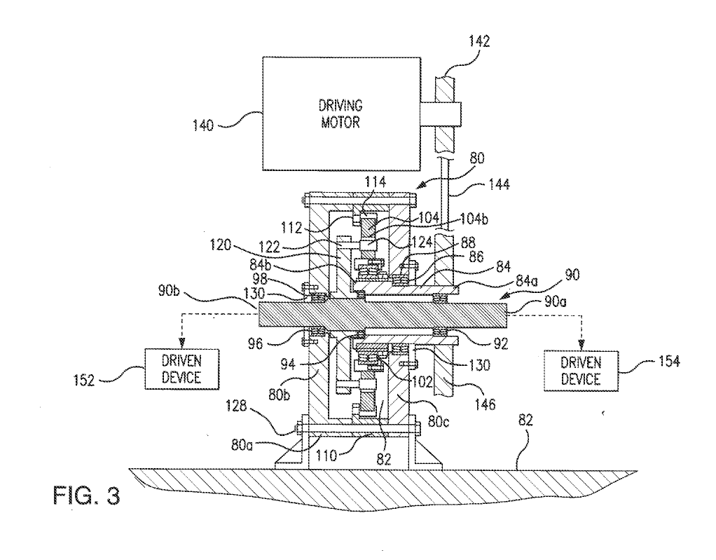

Referring now to FIGS. 3 and 4, according to the present invention, a cycloidal gearing arrangement is provided that includes a stationary sectional housing 80 supported by a fixed base 82, which housing includes a sectional cylindrical side wall 80a, and a pair of vertical end walls 80b, 80c that cooperate with the side wall to define a housing chamber 82. A tubular input shaft 84 is rotatably supported intermediate its ends by an input shaft bearing 86 within a first opening 88 contained in the first housing end wall 80c. A cylindrical output shaft 90 is rotatably supported concentrically within the input shaft 84 by first and second output shaft bearings 92 and 94. One first end 90a of the output shaft extends outwardly from the adjacent end of the input shaft 84, and the second output shaft end 90b extends outwardly from the adjacent end of the input shaft and outwardly of the housing chamber 82 via a third output shaft bearing 96 mounted in a second housing opening 98 contained in the housing second end wall 80b opposite the first wall opening 88.

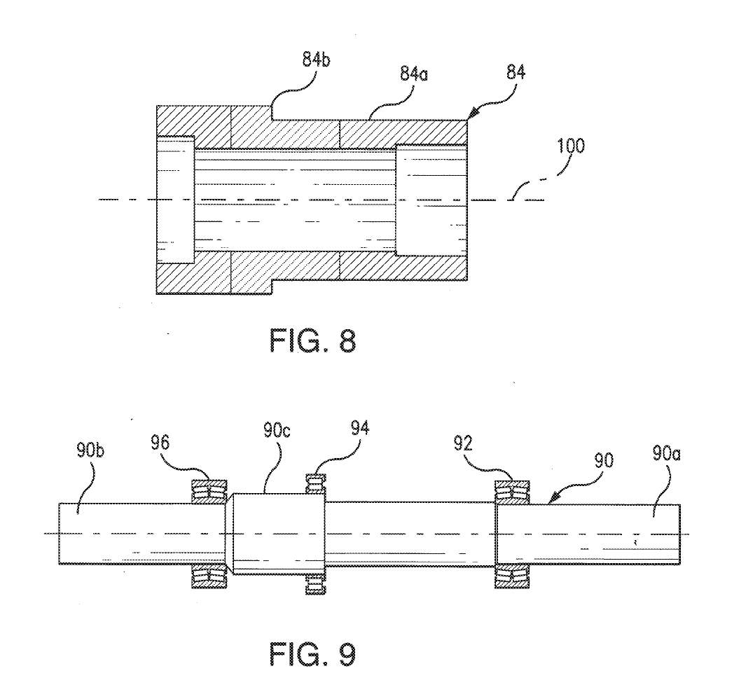

As shown in FIG. 8, the tubular input shaft 84 is an eccentric shaft including a main uniformly-cylindrical tubular portion 84a having a longitudinal centerline 100, and an eccentric end portion 84b having a laterally offset centerline. Rotatably supported on this eccentric end portion 84b within the housing chamber 82 by a cycloidal disk bearing 102 is an annular cycloidal disk 104. The outer circumferential surface of the cycloidal disk contains a plurality of circumferentially spaced first cam recesses 104a, and the central portion of the cycloidal disk contains a plurality of circularly spaced cam openings 104b. Annular pin ring 110, which comprises a section of the rigid cylindrical wall of the stationary housing 80, has an annular internal flange portion that carries a plurality of circumferentially-spaced axially-extending stationary pins 112 upon which are rotatably mounted a plurality of pin ring rollers 114, respectively, that engage the wall surfaces of the cycloidal disk outer cam grooves 104a, respectively.

Non-rotatably connected in keyed or splined relation concentrically upon an enlarged intermediate portion 90c (FIG. 9) of the output shaft 90 within the housing chamber 82 is an annular power transfer disk 120 which carries a plurality of circularly-spaced axially-extending power transfer disk pins 122. Rotatably mounted on these pins 122 are a plurality of transfer disk rollers 124 that extend respectively into the cam openings 104b contained in the cycloidal disk 104. The housing sections are bolted together by bolt means 128, and the various bearings are maintained in place by a plurality of bearing retainer plates 130, respectively.

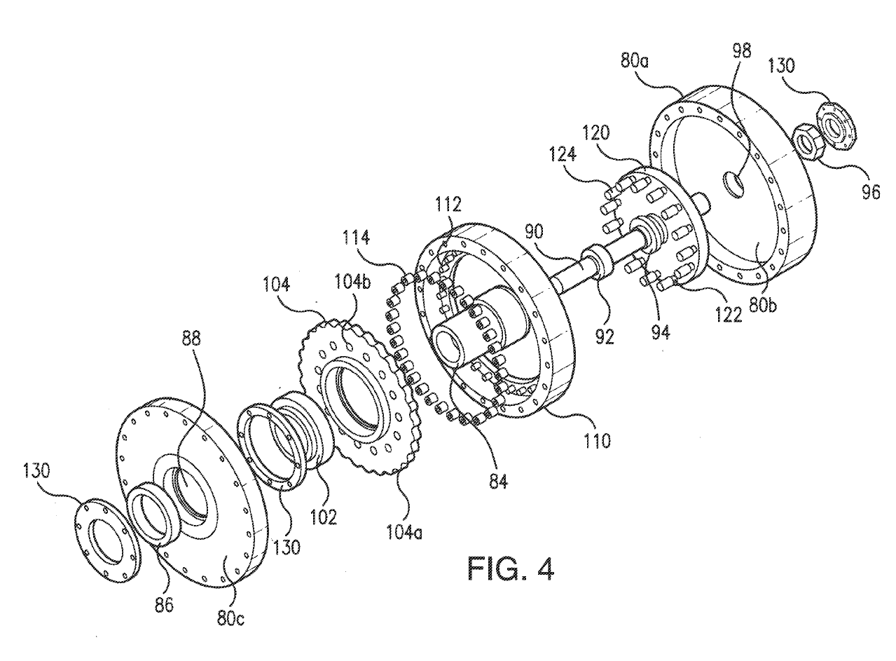

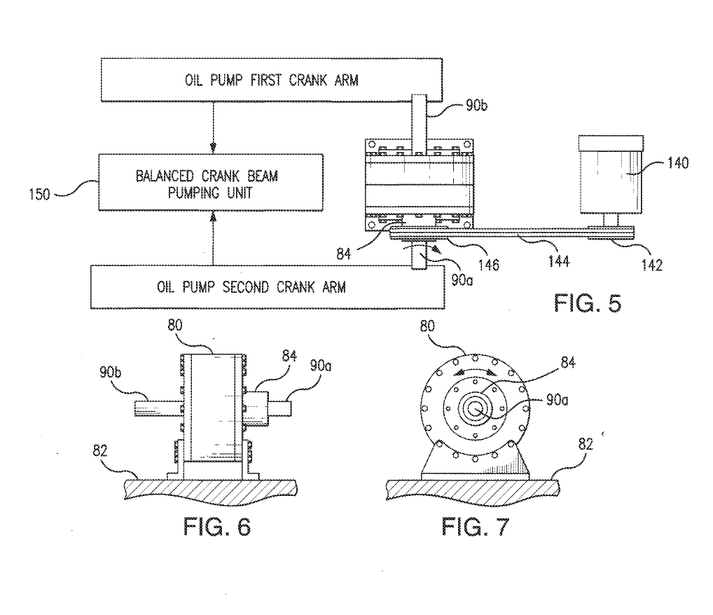

Referring now to FIGS. 3 and 5, the high-speed input shaft 84 is driven by the high-speed driving motor 140, such as an electric motor, diesel engine or the like, via drive pulley 142 non-rotatably keyed or splined onto the motor output shaft, flexible endless belt or chain member 144, and driven pulley 146 that is non-rotatably keyed or splined onto the input shaft 84. Thus, the output shaft of the motor 140 is parallel with the input shaft 84. As shown in FIG. 5, the two ends 90a and 90b of the low-speed output shaft are normally connected with the drive crank arms of a walking beam type oil well pumping unit 150. Alternatively, as shown in FIG. 3, the output shaft ends could be connected with separate rotatably-driven devices 152 and 154.

In operation, rotation of the high-speed input shaft 84 by the drive motor 140 causes the eccentric portion produces planetary displacement of the cycloidal disk and cooperation between pin ring rollers and the cam groves 104a in the outer periphery of the cycloidal disk. The cam openings 104b in the cycloidal disk cooperate with the power transfer rollers 124 to drive the power transfer disk 120 and the output shaft at a reduced speed. As is known in the art, as the eccentric bearing drives the cycloidal disk, the cycloidal disk rotates in one direction relative to its own center. However, the cycloidal disk advances in the opposition direction relative to the center of the speed reducer. The power transfer rollers convert the wobbling motion of the cycloidal disk into the smooth concentric movement of an output shaft. Thus, the mechanism converts the rocking motion of the eccentric bearing into the wobbling planetary motion of a cycloidal disk. This motion is then transformed to the smooth concentric movement of the output shaft through the power transfer rollers. The speed reduction is achieved, and torque transmission is accomplished.

While in accordance with the provisions of the Patent Statutes the preferred forms and embodiments of the invention have been illustrated and described, it will be apparent to those skilled in the art that changes may be made without deviating from the invention described above.

What is claimed is:

1. A compact dual-output speed-reducing arrangement for driving an oil well pump or the like, comprising:
(a) a stationary high-speed drive motor (140) having a rotary output shaft;
(b) a stationary housing (80) arranged adjacent said drive motor, said housing including a side wall (80a), and first and second parallel spaced vertical end walls 80a, 80b) cooperating with said side wall to define a chamber (82);
(c) a cycloidal speed-reduction arrangement connected with said housing, said cycloidal speed-reduction arrangement including:
(1) a horizontal tubular high-speed input shaft (84) journalled intermediate its ends in a first opening (88) contained in said first housing end wall, said high-speed input shaft having a cylindrical first end portion (84a) that extends outwardly from said fixed housing, and an eccentric cylindrical second portion (84b) that is arranged within said housing chamber;
(2) a horizontal low-speed output shaft (90) journalled concentrically within said high-speed input shaft, said low-speed output shaft having a first end portion (90a) that extends outwardly beyond said high-speed input shaft first end portion, said low-speed output shaft having a second end (90b) portion that extends outwardly beyond said high speed shaft second end portion, said low-speed output shaft second end portion being journalled within, and extending through, a second opening (98) contained in said housing second end wall opposite said first opening; and
(3) cycloidal speed-reduction means arranged in said chamber and connected between said high-speed input shaft and said low-speed output shaft, said cycloidal speed-reduction means including:
(a) an annular pin ring member (110) connected with said fixed housing in concentric spaced relation about said high-speed input shaft and said low-speed output shaft;
(b) an annular cycloidal disk (104) journalled on said high-speed input shaft eccentric second end portion in concentrically spaced relation within said pin ring member;
(c) an annular power transfer disk (120) arranged concentrically about and non-rotatably connected with said low-speed output shaft second end portion; and
(d) first roller and cam means (114, 104a) connecting said pin ring member with said cycloidal disk, and second roller and cam means (124, 104b) connecting said power transfer disk with said cycloidal disk;
(d) connecting means (142, 144, 146) connecting said drive motor output shaft with said high-speed input shaft first end portion; and
(e) a rotatably-driven device (150; 152, 154) connected with at least one of said low-speed output shaft first and second end portions.

2. A dual-output speed-reducing arrangement as defined in claim 1, wherein said drive motor output shaft and said speed-reducing arrangement input shaft are parallel;
and further wherein said connecting means comprise pulley and endless flexible member means.

3. A dual-output speed-reducing arrangement as defined in claim 1, wherein said housing side wall is generally cylindrical; and further wherein said chamber is cylindrical.

4. A dual-output speed-reducing arrangement as defined in claim 3, wherein said first pin and cam means comprises a plurality of axially-extending circularly-arranged rollers carried by said pin ring member for cooperation with corresponding circumferentially spaced first cam grooves contained in the outer periphery said cycloidal disk.

5. A dual-output speed-reducing arrangement as defined in claim 4, wherein said second pin and cam means comprises a plurality of axially-extending circularly-arranged rollers carried by said power transfer disk for cooperation with corresponding circularly arranged second cam openings contained in said cycloidal disk.

6. A dual-output speed-reducing arrangement as defined in claim 1, wherein said rotatably-driven device comprises a crank-balanced oil well pumping unit (150) including a pair of parallel rotatable crank arms connected with said output shaft end portions, respectively.

7. A dual-output speed-reducing arrangement as defined in claim 1, wherein a pair of rotatably-driven devices (152, 154) are connected with said output shaft end portions, respectively.

8. A dual-output speed-reducing arrangement as defined in claim 1, and further including an input shaft bearing (92) supporting said input shaft for rotation in said first housing opening.

9. A dual-output speed-reducing arrangement as defined in claim 8, and further including cycloid disk bearing means (102) supporting said cycloid disk for rotation about said input shaft eccentric portion.

10. A dual-output speed-reducing arrangement as defined in claim 9, and further including first and second output shaft bearing means (92, 94) supporting said output shaft for concentric rotation within said input shaft, and a third output shaft bearing means (96) supporting said output shaft for rotation in said second housing opening.

11. A dual-output speed-reducing arrangement as defined in claim 3, wherein said housing is sectional; and further wherein said pin ring member comprises a section of said housing cylindrical wall.
